(19) United States
(12) Patent Application Publication
(10) Pub. No.: US 2006/0010739 A1
(43) Pub. Date: Jan. 19, 2006

(54) Thin profile, modular menuboard

(75) Inventors: Mark Hartung, Sussex, WI (US); Paul Steinbrenner, West Bend, WI (US)

Correspondence Address: QUARLES & BRADY LLP, 411 E. WISCONSIN AVENUE, SUITE 2040, MILWAUKEE, WI, 53202-4497, US

(73) Assignee: The Howard Company, Inc.

(21) Appl. No.: 11/170,580

(22) Filed: Jun. 29, 2005

Related U.S. Application Data
(60) Provisional application No. 60/584,285, filed on Jun. 30, 2004.

(51) Int. Cl. G09F 13/18

(52) U.S. Cl. 40/546

(57) ABSTRACT

A modular, thin profile backlit display menuboard provides multiple display panels supported at their rear edge against horizontal tracks which provide for support, leveling, and cable ways for simple interconnection of an arbitrary number of display panels to create a flexible menuboard system.

### CROSS-REFERENCE TO RELATED APPLICATIONS

This application claims the benefit of U.S. Provisional Application 60/584,285 filed Jun. 30, 2004, and hereby incorporated by reference.

### STATEMENT REGARDING FEDERALLY SPONSORED RESEARCH OR DEVELOPMENT

### BACKGROUND OF THE INVENTION

The present invention relates to backlit menuboards and more particularly to menuboards formed from combinations of edge lit display panels.

Particularly in fast food restaurants, there may be one or more menuboards presenting the restaurant menu and the prices of the menu items offered for sale. Typically, these menuboards consist of a number of display panels showing different photographic reproductions of the items offered for sale, together with prices and description. Quite often these menuboards are backlit with the photograph, letters, and number translucent to emit the light. The backlighting may be contained in a housing behind the display panel which is normally mounted to a wall often specially constructed over the counter.

U.S. Pat. No. 5,379,540, assigned to the assignee of the present invention and hereby incorporated by reference, describes a modular menuboard where multiple light boxes are abutted side-to-side. Electrical conductors pass through the walls of these boxes allowing electricity to be introduced at one end of the menuboard only to simplify wiring. The modular design allows the menuboard to be provided in different sizes and flexibly expanded if additional menu space is needed in a restaurant.

Backlit menuboards, using light boxes, are relatively bulky and may not be compatible with the aesthetic concerns of restaurants who want a visually lighter sign system. In such cases, opaque printed placards may be used and illuminated from the front by directional lighting from track lighting or the like. Such an approach entails expense and effort in installing additional lighting to illuminate the signs. Further, front-illuminated signs do not provide the luminosity and color saturation often desired for photographs of food items.

### BRIEF SUMMARY OF THE INVENTION

The present inventors have recognized that thin profile, backlit menuboards may be constructed by using edge lighting in which a transparent plate is illuminated from the edge and placed behind photographs, text or numbers on translucent sheets to provide for a thin backlight. While such edge illuminated panels are well known, the inventors provide a practical modular system suitable for menuboards through the use of a track which both supports the panels and which provides a cable way allowing jumpers to interconnect separated panels while being hidden within the cable way. The system generally provides a visually light and open menuboard that may be easily installed and expanded without the need for special illumination or complex electrical wiring.

Specifically, the present invention provides a menuboard system having a set of display panels, each having a transparent plate supporting display elements for backlighting. Lamps at the upper and lower edges of the transparent plate provide for edge lighting of the transparent plate and are covered by shrouds. Rear-facing mounting elements support the panels on a horizontal track having a rear portion mountable on a wall and a front portion receiving the rear-facing mounting elements. A set of electrical jumpers extends between the shrouds to provide sequential electrical connection among the display panels so that power may be introduced to the menuboard system at a display panel at one end of the horizontal track and communicated to a variable number of additional display panels on the track.

It is thus one object of at least one embodiment of the invention to provide a simple method of collecting a series of edge lit panels into a practical menuboard having reduced installation and wiring costs. The wall tracks allow the panels to be quickly assembled, aligned, and interwired with only a single electrical connection to the power line.

The rear facing mounting elements may be downwardly extending hooks, and the front portion of the horizontal track may be an upwardly extending flange receiving the downwardly extending hooks.

Thus it is an object of at least one embodiment of the invention to provide a mounting system that allows for ready adjustment in spacing between the display panels and that flexibly allows multiple numbers of display panels to be installed and removed without extensive remodeling.

The track may provide a cable guide for the jumpers, for example, a groove in the track opening toward the display panels beneath the upwardly extending flange. A cableway cover may have a downwardly extending lip engaging the upwardly extending flange to fit over the groove.

It is yet another object of at least one embodiment of the invention to provide an aesthetically acceptable method of connecting power to multiple edge lit panels. Interconnection through the shrouds and supporting tracks provides electrical power to the panels without destroying the visual lightness of the edge lit panels.

The connectors may be located at four comers of the display panels with upper and lower connectors wired respectively to upper and lower lamp assemblies, and with an intraboard jumper connecting one of the upper connectors to one of the lower connectors, preferably on opposite sides of the display panel.

It is thus another object of at least one embodiment of the invention provide a method of communicating electrical power from the top shroud to the bottom shroud that also allow simple interconnection between display panels. A simple reconfiguration of the intraboard jumper allows successive panels to be connected at their upper, then lower, then upper edges, in a zigzag pattern.

Two horizontal tracks may be employed, each having cable guides. Jumpers associated with the upper connectors may be guided by an upper track and the jumpers associated with the lower connector may be guided by a lower track.

It is another object of at least one embodiment of the invention to provide for short wiring paths that are hidden when following a zigzag pattern of wiring.

The shrouds may cover only the top and bottom edges of the transparent plate and may be connected by struts extending behind the transparent plate.

It is thus another object of at least one embodiment of the invention to provide for an easily mounted thin profile backlit panel that preserves a view of the bare edge of the panel preserving the thin profile aesthetic.

The lamps may be cold cathode fluorescent tubes extending along the upper and lower edge of the transparent plate.

It is thus another object of at least one embodiment of the invention to provide extremely compact illumination that may be covered by a thin profile shroud.

The cover on the track covering the wire guide way may abut elements on each of the panels to control the space along the horizontal track between the display panels.

It is thus another object of at least one embodiment of the invention to allow for simple installation of the panels with an aesthetically pleasing consistency of spacing.

The cover may be formed from a metal sheet.

It is thus another object of at least one embodiment of the invention to provide a spacer/cover that may be trimmed using simple tools on site.

These particular objects and advantages may apply to only some embodiments falling within the claims, and thus do not define the scope of the invention.

### BRIEF DESCRIPTION OF THE DRAWINGS

FIG. 1 is a front elevational view of a modular sign system according to the present invention showing a number of thin profile display panels supported on horizontal mounting tracks, the display panels including transparent plates positioned between upper and lower shrouds;

FIG. 2 is a side elevational view in fragment of the upper shroud of the display panel of FIG. 1 showing an extrusion forming the shroud such as contains a cold cathode fluorescent tube at the top edge of the transparent sheet and which supports plugs for removable jumpers between the display panels such as may fit within a wire guide in the horizontal track and within a display panel passing diagonally along the back;

FIG. 3 is a top plan view of the shroud of FIG. 2 showing positioning of the jumper wires within the cable guide of the horizontal track;

FIG. 4 is a vertical cross sectional view through the track of FIGS. 2 and 3 showing a guide cover fitting over the cable guide for holding a jumper cable therein;

FIG. 5 is a simplified, front elevational view of the display panels of FIG. 1 showing electrical wiring such as allows an alternate high/low or zigzag wiring between each display panel for simplified interconnection; and

FIG. 6 is a horizontal cross section through the display panel of FIG. 1 removed from the shroud showing a laminated assembly of the transparent plate, rear reflector, and front film elements, using a simple clamp mechanism.

### DETAILED DESCRIPTION OF THE PREFERRED EMBODIMENT

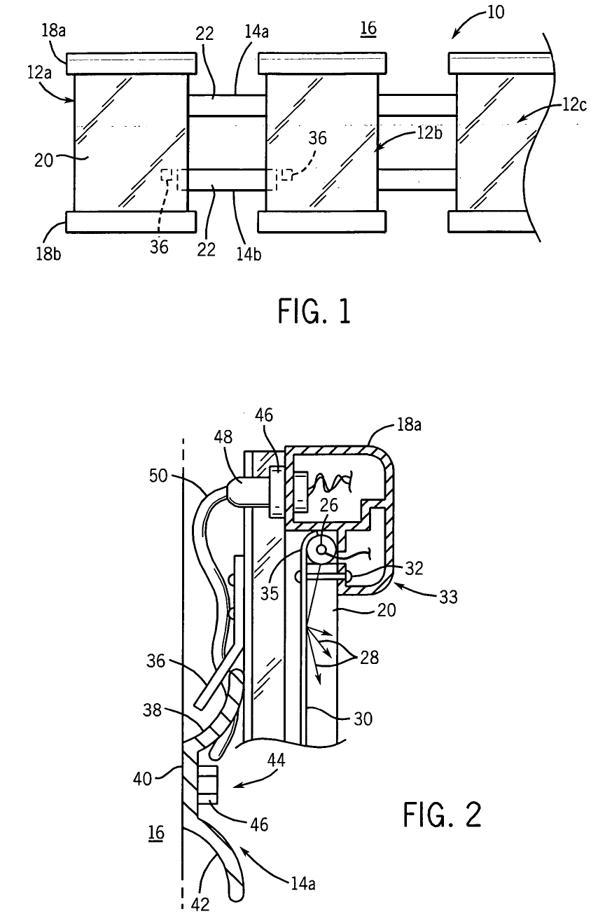

Referring now to FIG. 1, a thin profile menuboard 10 may include a number of display panels 12a through 12c arranged along parallel upper and lower tracks 14a and 14b. The upper and lower tracks 14a and 14b may be attached one above the other to a wall 16 or the like so as to orient the display panels 12a through 12c in vertical orientation and spaced horizontally along the tracks 14.

The display panels 12 provide an upper and lower shroud 18a and 18b separated by a transparent panel 20 against whose front surface a photographic film and/or transparent or translucent films containing letters and numbers may be placed to provide menu descriptions and prices. As will be described in greater detail below, each of the display panels 12 may be freely positioned horizontally along the tracks 14a and 14b restrained only in separation by covers 22 engaging at their left and right edges, track mounts 36 so as to enforce a regular spacing between the panels 12a through 12c defined by the length of the covers 22.

Referring now to FIG. 2, the shrouds 18 may be aluminum extrusions or the like having end caps and providing inwardly extending lips 33 that cover the upper and lower edges of the transparent panel 20 and that are attached to front of the transparent panel 20 at those edges to be supported thereby by means of rivets or fasteners 32 passing through the transparent panel 20 and a flange on the lips 33.

The shrouds 18 provide a housing containing a cold cathode fluorescent tube 26 aligned with upper and lower edges (only the upper edge is shown) of the transparent panel 20 so that light 28 extending from the generally cylindrical fluorescent tube 26 passes downward throughout the transparent panel 20. A reflective aluminum tape 35 may hold the cold cathode fluorescent tubes 26 to the edges of the transparent panel 20 so as to direct light into the edge that would otherwise be transmitted away from the edge. The light 28 is internally reflected off of a rear reflective layer 30 attached to the rear face of the transparent panel 20, as will be described in greater detail below, to provide for a diffuse forward directed light for backlighting of film and the like.

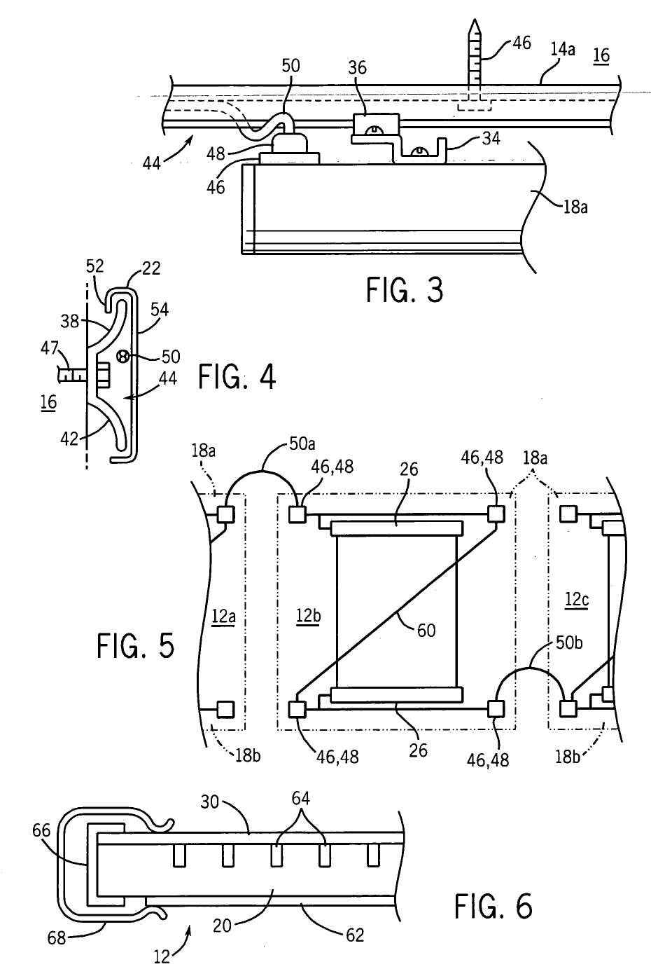

Referring to FIGS. 2 and 3, the shrouds 18 support at their rear surfaces, a pair of vertical struts 34 extending between the upper shroud 18a and the lower shroud 18b, the lower shroud 18b being essentially the mirror image of the upper shroud 18a. The struts 34 are parallel to each other, one on each of the right and left sides of the shrouds 18.

Each strut 34 holds on its rear surface two vertically displaced track mounts 36 having downward extending hook portions which may engage an upwardly extending flange 38 on the track 14a and 14b. The upwardly extending flange 38 is spaced away from a wall contacting vertical surface 40 of the track 14a, the latter which stabilizes the track 14a against the wall 16 with the upward flange 38 spaced slightly from the wall to receive the downward hook 52. The track 14a is substantially symmetrical about a horizontal axis also having a downwardly extending flange 42. The space between the flanges 38 and 42 provides a cable guide groove 44. Screws or bolts 47 passing through the track 14 into the wall to affix the track 14 to the wall so that the heads of the screws or bolts are contained within the cable guide groove 44.

Referring to FIGS. 2, 3 and 5, a rear side of each shroud 18a and 18b supports at their left and right edges electrical sockets 46 that may receive a two conductor plug 48 on a jumper 50, the latter of which may pass downward into the cable guide groove 44 and there along to a second display panel 12 to be received by a second socket 46 at a corresponding second plug 48 on the jumper 50. The vertical strut 34 provides an offset of the track mounts 36, spacing the shroud 18 away from the wall 16, to allow clearance for the plug 48.

As shown in FIG. 4, the length of the jumper 50 between the display panels 12 may fit within the cable guide groove 44 beneath a cover 22 fitting over the track 14. The cover 22 has a downwardly extending hook 52 engaging the upwardly extending flange 38 and a downwardly extending front portion 54 covering the cable guide groove 44 to provide protection to and covering of the jumper 50 in between the display panels 12 fully hiding interconnecting wiring. The covers 22 may be fabricated of sheet metal, and therefore may be trimmed with shears in the field to provide for variations and separations of the display panels 12, any irregularity in the trimming being covered by the display panels 12 themselves. The tracks 14 may be installed with simple carpentry skills and eliminate the need for difficult wiring within the wall.

Referring to FIG. 5, by providing sockets 46 in each of the top left and right, and bottom left and right edges of the display panels 12 on the shrouds 18, an interconnection between display panels 12 can be performed at top edges by jumpers 50a and at bottom edges by jumper 50b for an arbitrary number of display panels 12. Wiring internal to the top shroud 18a passes from an upper left socket 46 to the cold cathode fluorescent tube 26 at the top of the display panel 12 (specifically to a power supply feeding the cold cathode fluorescent tube 26, but not shown for clarity), then to the rightmost socket 46.

In this case, where jumper 50a is connected to the top left edge of the shroud 18a, a diagonal jumper 60 may be connected to the socket 46 on the upper right side of shroud 18a to socket 46 on the lower left side of shroud 18b.

The socket 46 on the lower left side of the shroud 18b is then connected to the lower cold cathode fluorescent tube 26 (power supply), and then to the socket 46 on the lower right hand side used with jumper 50b to connect to display panel 12c.

It will be understood that in the next connected display panel 12c, the jumper 60 (not shown) may be connected to the socket 46 on the upper left side of shroud 18a to socket 46 on the lower right side of shroud 18b.

Each of jumpers 50a and 50b may be fed through the guide way formed by cable guide groove 44 shown in FIG. 4 in different of the tracks 14a and 14b.

Referring now to FIG. 6, the transparent panel 20 may, for example, be Lexan or other clear plastic material. A photographic film 62 or transparent lettering may be attached to the front face of the transparent panel 20 for transmission of light therethrough and a reflective layer 30 at its rear face for reflecting light toward the front face. As is well known in the prior art, a series of grooves 64 or light absorbing or light reflecting stripes may be placed on the rear surface of the transparent panel 20, for example, having variation in depth or width proportional to the falloff in light as light passes downward or upward from the cold cathode fluorescent tube 26 to provide a more even illumination from light directed forward out of the transparent panel 20.

The film 62 may be held to the front of the transparent panel 20 by means of a spring clip 68, for example, an elongate C-shaped plastic channel that may clip over the edges of the transparent panel 20 allowing both retention and removal of the film 62. The spring clip 68 is essentially the size of the edge of the transparent panel 20 so as to provide and preserve the thin profile aesthetic of the display panels 12. A reflective aluminum tape 66 may be placed on the edges of the transparent panel 20 so as to return light that would otherwise be transmitted out of the edge.

Display panels 12 may also be suspended on a serpentine channel or suspended channel as described in co-pending U.S. application Ser. No. ______, entitled Serpentine Menu Board System, and assigned to the same assignee as the present invention and hereby incorporated by reference.

It is specifically intended that the present invention not be limited to the embodiments and illustrations contained herein, but include modified forms of those embodiments including portions of the embodiments and combinations of elements of different embodiments as come within the scope of the following claims.

We claim:

1. A menuboard system comprising:
a set of display panels each providing:
(i) a transparent plate supporting display elements for backlighting;
(ii) lamps at upper and lower edges of the transparent plate for edge lighting of the transparent plate;
(iii) shrouds covering the lamps; and
(iv) rear facing mounting elements;
at least one horizontal track having a rear portion mountable on a wall and a front portion receiving the rear facing mounting elements to thereby support the display panels; and
a set of electrical jumpers extending between the shrouds to provide sequential electrical connections among the display panels so that power may be introduced to the menuboard system at a display panel at one end of the horizontal track and communicated to a variable number of additional display panels on the track.

2. The menuboard system of claim 1 wherein the rear facing mounting elements are downwardly extending hooks and the front portion of the horizontal track is an upwardly extending flange receiving the downwardly extending hooks.

3. The menuboard system of claim 1 wherein the track further provides a cable guide for the jumpers.

4. The menuboard system of claim 3 wherein the cable guide is a groove in the track opening toward the display panels when the display panels are mounted on the track, the groove being positioned below an upwardly extending flange receiving downwardly extending hooks of the rear facing mounting elements.

5. The menuboard system of claim 4 further including a cableway cover having a downwardly extending lip engaging with the upwardly extending flange to fit over the groove.

6. The menuboard system of claim 1 wherein jumpers are electrical cords releasably connecting to connectors that engage corresponding connectors on the shrouds.

7. The menuboard system of claim 6 wherein the connectors are located at each of four comers of the display panels.

8. The menuboard system of claim 7 wherein a first upper connector on a first side of the display panel is wired to an upper lamp assembly, then to a second upper connector on a second side of the display panel, and a first lower connector on the first side of the display panel is wired to a lower lamp assembly, then to a second lower connector on the second side of the display panel, and including an intraboard jumper for connecting one of the first and second upper connectors to one of the first and second lower connectors.

9. The menuboard system of claim 8 wherein the intraboard jumper is sized to connect between upper and lower connectors on opposite sides of the display panel.

10. The menuboard system of claim 7 including two horizontal tracks, each having a cable guide wherein the jumpers associated with the upper connectors may be guided by an upper track and the jumpers associated with the lower connectors may be guided by the lower track.

11. The menuboard system of claim 1 wherein the track has upwardly and downwardly extending flanges spaced from a wall mounting surface.

12. The menuboard system of claim 1 wherein the track includes centered holes for receiving fasteners to attach the track to a wall.

13. The menuboard system of claim 1 wherein the rear reflective surface provides a vertical gradient of reflection offsetting a drop-off of intensity with distance from the lamps.

14. The menuboard system of claim 1 wherein the shrouds cover only top and bottom edges of the transparent plate and are connected by struts extending behind the transparent plate.

15. The menuboard system of claim 1 wherein lamps are cold cathode fluorescent tubes extending along the upper and lower edges of the transparent plate.

16. A menuboard system comprising:
a set of display panels providing edge illuminated transparent plates supporting display elements for backlighting, the display panels including on a rear surface downwardly extending hooks;
at least one horizontal track having a rear surface mountable on a wall and an upwardly extending lip spaced from the wall to receive the downwardly extending hook, the track further providing a wire guide way; and
a cover having a downwardly extending lip engaging with the upwardly extending lip to fit over the track to cover the wire guide way.

17. The menuboard system of claim 16 wherein ends of the cover between display panels abut elements on each panel to control a space along the horizontal track between display panels.

18. The menuboard system of claim 17 wherein the cover is sheet metal.
